(19) United States
(12) Patent Application Publication
(10) Pub. No.: US 2009/0294677 A1
(43) Pub. Date: Dec. 3, 2009

(54) METHOD FOR SIGNAL INTENSITY CORRECTION IN WAVEGUIDE SENSORS

(75) Inventors: Alexandre Izmailov, Toronto (CA); Stephan Schwers, Koln (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Healthcare Diagnostics Inc., Tarrytown, NY (US)

(21) Appl. No.: 12/300,797

(22) PCT Filed: May 17, 2007
(86) PCT No.: PCT/IB07/04200

§ 371 Date: Aug. 5, 2009

Related U.S. Application Data
(60) Provisional application No. 60/747,519, filed on May 17, 2006.

(51) Int. Cl. G01N 21/64; G01T 1/20

(52) U.S. Cl. 250/362; 250/473.1

(57) ABSTRACT

Methods are provided for enhancing the detection of analytes with waveguides by accounting for cumulative light absorptions attributable to the presence of one or more analytes in a sample as well as the waveguide material.

### CROSS REFERENCE TO RELATED APPLICATION

This application claims the benefit of the filing date of U.S. Provisional Patent Application No. 60/747,519, filed May 17, 2006, the disclosure of which is incorporated, in its entirety, by this reference.

### TECHNICAL FIELD OF THE INVENTION

The present invention relates to methods for improving the accuracy of optical measurements using waveguide sensors.

### BACKGROUND OF THE INVENTION

Waveguide sensors have been utilized to observe a variety of optical properties including fluorescence, light scatter, refractive index, and changes in absorption. Waveguide sensors typically comprise a substrate and a sensing layer that is capable of binding a target analyte. Target analytes bound to the sensing layer interact with the light propagating through the waveguide resulting in an observable change in one or more optical properties.

Since waveguide sensors operate by distributing light through the waveguide, uniform light distribution across the sensor area is necessary for accurate measurements. Unfortunately, a number of factors impair the accuracy of measurements made using waveguide sensors. First, absorption in the waveguide and light scattering on impurities and areas with non-homogeneous refractive index distribution lead to attenuation of light intensity along the waveguide. Second, cumulative absorptions occurring at preceding sensing areas (or spots) along the path of light propagation also cause attenuation of light intensity. The cumulative effects of light absorption can be significant, resulting in systematic error of as much as 50% to 100%.

Accordingly, there is a need for improving accuracy of optical measurements using waveguides including fluorescence measurements.

### SUMMARY OF THE INVENTION

The present invention is directed to methods for improving the accuracy of fluorescence measurements using waveguides.

In one aspect, a method provides for correcting fluorescent measurements of a test sample, comprising providing a waveguide comprising a plurality of detection sites, contacting the waveguide with a test sample suspected of containing an unknown concentration of a target analyte, irradiating the waveguide, measuring fluorescence intensity values at the plurality of detection sites, multiplying the fluorescence intensity value specific to each detection site by a fluorescence correction coefficient, resulting in a corrected intensity value of excitation light.

In another aspect, a method provides for calculating a correction coefficient for use in a waveguide fluorescence measurement, comprising providing a waveguide comprising a plurality of detection sites, contacting the waveguide with a control sample comprising a known concentration of a target analyte, irradiating the waveguide, measuring fluorescence intensity values at the plurality of detection sites, calculating a fluorescence correction coefficient specific to each detection site, whereby multiplying the sample measurement by the fluorescence correction coefficient results in a corrected intensity value of excitation light.

In still another aspect, a method provides for detecting the presence or absence of a target analyte in a sample using a waveguide, comprising providing a waveguide comprising: a substrate, a waveguide film, and a plurality of detection sites capable of specifically binding a target analyte, contacting the waveguide with a sample suspected of containing the target analyte, irradiating the waveguide, measuring fluorescence intensity values at the plurality of detection sites, multiplying the measured fluorescence intensity value specific to each detection site by a fluorescence correction coefficient, resulting in a corrected intensity value of excitation light, whereby fluorescence is indicative of the presence of the target analyte.

In one embodiment, the fluorescence correction coefficient includes an excitation correction factor. In one embodiment, the excitation correction factor is ƒ₁ₖ, calculated according to the equation:

$${f}_{1 k} = {e}^{- α {\sum }_{i = 1}^{k - 1} {N}_{i}}$$

wherein α is the absorption coefficient of hybridized analyte at an excitation wavelength, k is the spot number, i is the spot number for one or more spots in a path to spot k, Nᵢ is the analyte concentration at a spot. In one embodiment, the corrected excitation intensity Iexₖ is calculated according to the equation:

Iexₖ=ƒ₁ₖ·Iex₀

where Iex₀ is the initial light intensity and ƒ₁ₖ is defined above. In another embodiment, the excitation correction factor accounts for analyte absorption at all detection sites preceding a specific detection site.

In one embodiment, an excitation correction factor is ƒ₂ₖ, calculated according to the equation:

ƒ₂ₖ=e^{-ξ(x}^{ₖ}^{-x}^{₀}⁾

where ξ is the coefficient of linear attenuation of the waveguide material at an excitation wavelength, xₖ is the k-th spot coordinate, and x₀ is the origin coordinate. In one embodiment, the corrected excitation intensity Iexₖ at a position of spot k is calculated according to the equation:

Iexₖ=ƒ₂ₖ·Iex₀

where Iex₀ is the initial light intensity. In another embodiment, the excitation correction factor accounts for waveguide-material absorption along the waveguide between a light source and a specific detection site.

In one embodiment, the excitation correction factor may be a composite of factors, i.e., comprising more than one correction factor, such as when ƒ₁ₖ and ƒ₂ₖ are simultaneously taken into account as composite factor ƒ₃ₖ, calculated according to the equation:

$${f}_{3 k} = {e}^{- ξ ( {x}_{k} - {x}_{0} )} \cdot {e}^{- α {\sum }_{i = 1}^{k - 1} {N}_{i}}$$

where ξ is the linear attenuation coefficient of the waveguide material at an excitation wavelength, xₖ is the k-th spot coordinate, x₀ is the origin coordinate, α is the absorption coefficient of hybridized analyte at the excitation wavelength, k is the spot number, i is the spot number for one or more spots in a path to spot k, and Nᵢ is the analyte concentration at a spot. In one embodiment, the corrected excitation intensity Iexₖ at a position of spot k is calculated according to the equation

Iexₖ=Iex₀·ƒ₃ₖ

where Iex₀ is the initial light intensity. In one embodiment, the excitation correction factor can account for analyte absorption at all detection sites preceding a specific detection site and waveguide-material absorption along the waveguide between a light source and the specific detection site.

In one embodiment, the one or more fluorescence correction coefficients include an emission correction factor. In one embodiment, the emission correction factor is ƒ₁ₖ, calculated according to the equation:

$${f}_{1 k} = {e}^{- α {\sum }_{i = 1}^{k - 1} {N}_{i}}$$

where α is the absorption coefficient of hybridized analyte at an excitation wavelength, k is the spot number, i is the spot number for one or more spots in a path to spot k, and Nᵢ is the analyte concentration at a spot. In one embodiment, the corrected intensity of detected fluorescence I_{Fk} is calculated according to the equation:

I_{Fk}=Iex₀·ƒ₁ₖ·γₖ·Nₖ

where γₖ is the collection coefficient of fluorescent light at a spot k, Iex₀ is the initial light intensity, and Nₖ is the analyte concentration at spot k. In one embodiment, the emission correction factor accounts for analyte absorption at all detection sites preceding a specific detection site.

In one embodiment, the emission correction factor is calculated according to the equation:

ƒ₂ₖ=e^{-ξ(x}^{ₖ}^{-x}^{₀}⁾

where ξ is the coefficient of linear attenuation of the waveguide material at an excitation wavelength, xₖ is the k-th spot coordinate, x₀ is the origin coordinate. In one embodiment, the corrected intensity of detected fluorescence I_{Fk} is calculated according to the equation:

I_{Fk}=Iex₀·ƒ₂ₖ·γₖ·Nₖ

where γₖ is the collection coefficient of fluorescent light at a spot k, Iex₀ is the initial light intensity, and Nₖ is the analyte concentration at spot k. In one embodiment, the emission correction factor accounts for waveguide-material absorption along the waveguide between a light source and a specific detection site.

In one embodiment, the fluorescence correction coefficient comprises more than one correction factor. In one embodiment, the emission correction factor ƒ₃ₖ, calculated according to the equation:

$${f}_{3 k} = {e}^{- ξ ( {x}_{k} - {x}_{0} )} \cdot {e}^{- α {\sum }_{i = 1}^{k - 1} {N}_{i}}$$

wherein ξ is the linear attenuation coefficient of the waveguide material at an excitation wavelength, xₖ is the k-th spot coordinate, x₀ is the origin coordinate, α is the absorption coefficient of hybridized analyte at the excitation wavelength, k is the spot number, i is the spot number for one or more spots in a path to spot k, and Nᵢ is the analyte concentration at a spot. In one embodiment, the corrected intensity of detected fluorescence I_{Fk} is calculated according to the equation:

I_{Fk}=Iex₀19 ƒ₃ₖ·γₖ·Nₖ

where γₖ is the collection coefficient of fluorescent light at a spot k, Iex₀ is the initial light intensity, and Nₖ is the analyte concentration at spot k. In one embodiment, the emission correction factor accounts for analyte absorption at all detection sites preceding a specific detection site and waveguide-material absorption along the waveguide between a light source and the specific detection site.

In one embodiment, the one or more fluorescence correction coefficients include a multicolor excitation correction factor. In one embodiment, the multicolor excitation correction factor is ƒ₄ₖ, calculated according to the equation:

$${f}_{4 k} = {e}^{- {\sum }_{m = 1}^{p} {α}_{m} \cdot {\sum }_{i = 1}^{k} {N}_{i}}$$

wherein αₘ is the absorption coefficient of hybridized analyte at an excitation wavelength λₘ, k is the spot number, i is the spot number for one or more spots in the path to spot k, Nᵢ is the analyte concentration at a spot, and p is the number of colors used for labeling. In one embodiment, the corrected intensity of excitation light Iexₖ is calculated according to the equation:

Iexₖ=Iex₀·ƒ₄ₖ

where Iex₀ is the initial light intensity. In one embodiment, the multicolor excitation correction factor accounts for analyte absorption at all detection sites preceding a specific detection site at more than one wavelength of light.

In one embodiment, the multicolor excitation correction factor is calculated according to the equation:

ƒ₂ₖ=e^{-ξ(x}^{ᵢ}^{-x}^{₀}⁾

wherein ξ is the linear attenuation coefficient of the waveguide material at an excitation wavelength, xᵢ is the i-th spot coordinate, and x₀ is the origin coordinate. In one embodiment, the corrected intensity of excitation light Iexₖ is calculated according to the equation:

Iexₖ=ƒ₂ₖ·Iex₀

where Iex₀ is the initial light intensity. In one embodiment, the multicolor excitation correction factor accounts for waveguide-material absorption along the waveguide between a light source and a specific detection site.

In one embodiment, the fluorescence correction coefficient comprises more than one multicolor correction factor. In one embodiment, the multicolor excitation correction factor is ƒ₅ₖ, calculated according to the equation:

$${f}_{5 k} = {e}^{- {\sum }_{m = 1}^{p} {α}_{m} {\sum }_{i = 1}^{k} {N}_{i}} {e}^{- ξ ( {x}_{k} - {x}_{0} )}$$

wherein αₘ is the absorption coefficient of hybridized analyte at an excitation wavelength λₘ, k is the spot number, i is the spot number for one or more spots in the path to spot k, Nᵢ is the analyte concentration at a spot k, p is the number of colors used for labeling, Iexₖ is the corrected intensity of excitation light at a given position, i is the spot number for one or more spots in a path to spot k, ξ is the linear attenuation coefficient of the waveguide material at an excitation wavelength λₘ, xₖ is the k-th spot coordinate, and x₀ is the origin coordinate. In one embodiment, the corrected intensity of excitation light Iexₖ is calculated according to the equation:

Iexₖᵢ=ƒ₅ₖ·Iex₀

where Iex₀ is the initial light intensity. In one embodiment, the multicolor excitation correction factor accounts for analyte absorption at all detection sites preceding a specific detection site and waveguide-material absorption along the waveguide between a light source and the specific detection site at more than one wavelength of light.

In one embodiment, the plurality of detection sites is aligned in at least one linear column from a light source. In one embodiment, the plurality of detection sites is aligned in two or more linear columns. In one embodiment, the plurality of detection sites is aligned includes a linearly arranged column of two or more detection sites. In one embodiment, the plurality of detection sites includes a linear column of at least three detection sites. In one embodiment, the plurality of detection sites includes a row of detection sites not in linear order along the direction of propagated light. In one embodiment, the target analyte comprises one or more target analytes.

### BRIEF DESCRIPTION OF THE DRAWINGS

FIG. 1 is a cross-section of a planar waveguide sensor and the evanescent resonance condition of a waveguide platform.

FIG. 2 is a top view of a schematic illustration of a sensor platform with an array of spots for binding one or more analytes.

FIG. 3 is an experimentally observed fluorescence intensity distribution of a waveguide with a relatively low concentration of hybridized molecules.

FIG. 4 is an experimentally observed fluorescence intensity distribution of a waveguide with a relatively high concentration of hybridized molecules, showing a continual reduction of light intensity at locations as they are farther from a light source.

FIG. 5 is a bar graph showing fluorescence intensity continually decreasing at waveguide locations spaced sequentially from a light source with a uniform concentration of a target analyte.

FIG. 6 is a bar graph showing systematic reduction in fluorescence intensity at waveguide locations spaced sequentially from a light source with the concentration of a target analyte varying from one sensing location to another.

FIG. 7 is a graph of correction coefficients for waveguide sensing locations with the target analyte concentration is (1) constant at a low concentration, (2) constant at a high concentration, and (3) variable from one sensing location to another.

FIG. 8 is a graph of waveguide fluorescence (1) intensity measured but uncorrected, (2) intensity normalized (corrected) correction coefficients, and also the concentration of analyte for the fluorescence measurements at each sensing location divided by a factor of 1000.

### DETAILED DESCRIPTION OF THE INVENTION

Units, prefixes, and symbols may be denoted in their SI accepted form. Unless otherwise noted, the terms “a” or “an” are to be construed as meaning “at least one of.” The section headings used herein are for organizational purposes only and are not to be construed as limiting the subject matter described. All documents, or portions of documents, cited in this application, including but not limited to patents, patent applications, articles, books, and treatises, are hereby expressly incorporated by reference in their entirety for any purpose.

The luminescent phenomenon of fluorescence in a simplified form can be described as a three-stage process of energy transfer that occurs in certain molecules (generally, molecules with conjugated pi-systems such as polyaromatic hydrocarbons or heterocycles) called fluorophores or fluorescent dyes. The three-stage process begins with a molecule in an electronic ground state (S0) that undergoes excitation. Excitation (the first stage) results when a fluorophore absorbs a photon of energy or light hνₑₓ, creating an excited electronic singlet state (S1′).

The second stage of the fluorescence process is an excited-state lifetime which lasts for a finite period of time, typically 1-10 nanoseconds, resulting in an emission of a photon (fluorescence). Alternatively, a chemical reaction between the fluorophore and another molecule in its environment results in the energy of the excited singlet state being dissipated in a non-photon emission process (i.e., collisional quenching, fluorescent resonance energy transfer (FRET), or intersystem crossing). Non-emission processes depopulate the molecules available for fluorescence in the relaxed singlet state (S1). The fluorescence quantum yield represents the relative extent to which excitation and emission processes occur and is a ratio of the number of emission events compared to the number of absorption events.

The third stage of the fluorescence process is light emission. During emission, a photon of energy (hνₑₘ) is emitted, returning the fluorophore molecule to its ground state (S0). Due to energy dissipation during the exited-state lifetime (the second stage), the energy of the emitted photon is usually lower than the energy of the photon absorbed by the fluorophore (the first stage). Therefore, the emitted photon has a longer wavelength than the excitation photon. This difference in energy or wavelength represented by hνₑₓ-hνₑₘ is called the Stokes shift. The Stokes shift, in principle, imparts the advantageous sensitivity of fluorescence techniques, because the emission wavelength is isolated from the excitation wavelength. In contrast, absorption spectrophotometry measures transmitted light at the same wavelength.

The electronic transitions represented by hνₑₓ and hνₑₘ discussed in the three-stage process of fluorescence are also represented by energy spectra called the fluorescence excitation spectrum and fluorescence emission spectrum. These spectra represent energy states across a range of wavelengths (or frequencies). The range of both the fluorescence excitation and emission spectra are helpful parameters when two or more different fluorophores are simultaneously detected (such as in multicolor experiments). With few exceptions, the fluorescence excitation spectrum of a single fluorophore in dilute solution has the same shape as the corresponding absorption spectrum. Under the same conditions, the fluorescence emission spectrum is independent of the excitation wavelength due to the rapid (relative to light emission process) partial dissipation of energy during the excited-state lifetime (energy losses during the second stage of fluorescence) which cause all excited molecules to appear in the bottom of excited state energy level. As a result, all excited molecules start emitting light from the same energy level independently from the wavelength of excitation. The emission intensity is proportional to the amplitude of the fluorescence excitation spectrum at the excitation wavelength. Thus, excitation of a fluorophore at three different wavelengths (EX1, EX2, and EX3) does not change the emission profile (the wavelength(s) of emission) but does produce variations in the fluorescence emission intensity (EM1, EM2, and EM3) that correspond to the amplitude distribution in the excitation spectrum.

Beer's law (also called the Beer-Lambert law) defines the empirical relationship between absorption of light and the properties of the material through which the light is traveling. According to Beer's law, absorption (A) is the product of the absorption coefficient (sometimes called the molar absorptivity, (α), optical path length (l), and analyte (or solute) concentration (c). The relationship of these parameters can be represented by the following formula:

A=αlc

Fluorescence intensity is a function of several parameters, including intensity of excitation light and fluorescence quantum yield. The measured value of fluorescence intensity depends also on the light collection efficiency (γ) of the instrument and is typically linearly proportional to γ. Light collection efficiency may change insignificantly for well-designed optical systems, but also may vary noticeably (up tot 50% and even more) across a field of view. In dilute solutions or suspensions, measured fluorescence intensity is linearly proportional to these parameters. When sample absorption exceeds about 0.05 a.u. (arbitrary units) in a 1 cm pathlength, the relationship becomes nonlinear and measurements may be distorted by artifacts such as self-absorption and the inner-filter effect. The following formula can be used for evaluation of reduction of intensity of excitation light due to absorption:

$$\frac{{I}_{1}}{{I}_{0}} = {e}^{- α lc}$$

The initial intensity (I₀) of the excitation light and the intensity of the light transmitted through a material (I₁) are related. Because fluorescence quantitation is dependent on the instrument, fluorescent reference standards can be used for calibrating measurements made at different times or using different instrument configurations.

In more complex fluorescence assays, a multicolor labeling experiment entails the deliberate introduction of two or more probes to simultaneously monitor different functions or aspects of an analyte or assay. Multicolor labeling experiments may also be conducted to monitor multiple analytes. Signal isolation and data analysis for each probe can be facilitated by maximizing the spectral separation of the multiple emissions (EM1, EM2, EM3, etc.). Consequently, fluorophores with narrow spectral bandwidths are useful in multicolor applications because they are more readily distinguished from other fluorophores. A multicolor labeling experiment using more than one dye would exhibit strong absorption at a coincident excitation wavelength or wavelengths while generating well-separated emissions from each respective dye.

Since there are many available fluorophores, the selection of any particular fluorophore can readily be made by one skilled in the art, based on the desired criteria for a given assay objective. For example, a fluorophore may be selected because it enables a desired wavelength range, Stokes shift, or spectral bandwidth, while allowing flexibility in design of multicolor labeling experiments. The fluorescence output of a given dye depends on the efficiency with which it absorbs and emits photons, and its ability to undergo repeated excitation/emission cycles. Absorption and emission efficiencies are most usefully quantified in terms of the molar extinction coefficient (ε) for absorption and the quantum yield (QY) for fluorescence. Both are constants under specific environmental conditions. The value of ε is specified at a single wavelength (usually the absorption maximum), whereas QY is a measure of the total photon emission over the entire fluorescence spectral profile.

Waveguide Assays Using Fluorescence

A variety of fluorescence detection systems have been used to conduct analyte detection assays. One type of fluorescent system is a waveguide sensor. Waveguide sensor fluorescence detection systems typically include a substrate, a waveguide film, and a sensing layer. The substrate imparts structural stability for the sensor and includes a medium interfacing a waveguide film from one side. The substrate has a refractive index lower than refractive index of the waveguide film. The waveguide film, often a transparent material, has a relatively high refractive index (2.1 for Ta₂O₅ for example). The waveguide film serves as the medium through which light propagates along the waveguide based on the phenomenon of total internal reflection (TIR). TIR occurs in the waveguide film at interfaces with the waveguide film, such as with the substrate on one side and the analyte solution on the other side. If inorganic material is used as a waveguide film, an additional polymer layer can be deposited on top of the waveguide film. This layer can then be used to allow placement of capture molecules capable of binding to a target analyte. For example, when working with biological samples, the sensing layer may include monoclonal antibodies that bind a target analyte. Thus, the sensing layer interacts with and captures the target analyte, resulting in a change in mass or a chemical reaction that results in a detectable change in some optical property.

In addition, waveguide fluorescence detection systems usually include other components. These components can include a light source, such as a laser, and a coupling device such as a prism or diffraction grating for directing light from the light source into the waveguide sensor. Light then propagates throughout the waveguide and, simultaneously, an evanescent wave passes through the sensing layer. If a target analyte is present, light is absorbed at a sensing location where a target analyte is bound. In one embodiment, the target analyte itself can serve as a fluorophore. In another embodiment, a dye or fluorophore associates with the analyte at the binding site. In still other embodiments, both the analyte and another molecule can both act as fluorophores. The light source supplies light to excite fluorophores at detection sites (i.e., sensing locations or spots) that emit photons outward from the surface of the array when a target analyte is present.

Fluorescent emissions may be detected through a reading system that can include a combination of lenses and optical filters to capture an image. A captured image obtained by a reading system can be reconstructed using a software interface. In the case of systems with waveguides, the waveguide operates by illuminating simultaneously all sites with molecules hybridized to the surface. In this way, waveguides operate in a manner distinct from other fluorescent optical systems, such as confocal microscopy. In nonwaveguide fluorescence techniques, optically detected spots on a surface are illuminated one at the time in a consecutive manner. In waveguide fluorescent techniques, a more efficient imaging approach can be achieved by simultaneously illuminating detection spots. CCD or CMOS cameras can be used for waveguide fluorescent imaging. A system with a waveguide sensor may be used with image registration and software image analysis.

The data obtained from fluorescent detection systems can allow both qualitative and quantitative detection of an analyte or analytes.

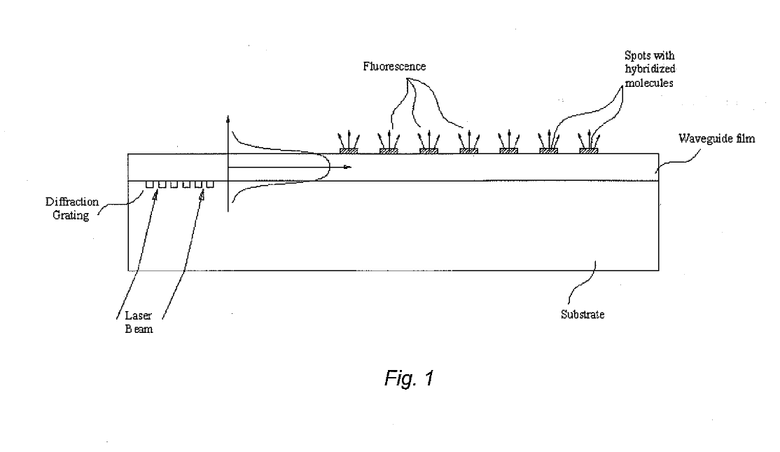

Waveguides can be constructed to propagate electromagnetic waves over a wide region of the electromagnetic spectrum including optical frequency ranges. Referring to FIG. 1, a waveguide (10) includes a substrate (12) and a waveguide film (14) with a refractive index higher than the refractive index of the substrate. A material of the waveguide film (14) can be Ta₂O₅, TiO₂, or other appropriate material. A light source (not shown) such as a laser can be used to generate electromagnetic radiation (light) (16) that is coupled using a diffraction grating (18) or prism (not shown), or other coupling component to the waveguide. Light then propagates along the waveguide film (14) simultaneously creating an evanescent wave. On one surface of the waveguide film (14), sensing areas or spots (20) may be distributed in an array arrangement. The spots may have one or more capture molecules (probes) capable of binding to a target analyte. As the evanescent wave leaks out into or passes through the area where the capture molecules may be bound (such as by hybridization to an analyte), the analyte or the analyte in combination with a fluorophore (such as a dye) can then undergo fluorescent excitation and result in a fluorescent emission.

Various fluorophores such as dyes may be used as labels in waveguide sensors and are well-known in the art. Examples of such fluorophores include rhodamine, fluorescein, Cy-family of dyes, for example, Cy3, Cy5, Cy5.5 or Cy7. The Alexa Fluor® (Molecular Probes, Inc. Eugene, Oreg.) family of dyes can be used as well (e.g., AlexaFluor® 647 and AlexaFluor® 660). One advantage from using AlexaFluor® dyes arises from their high photo stability and brightness.

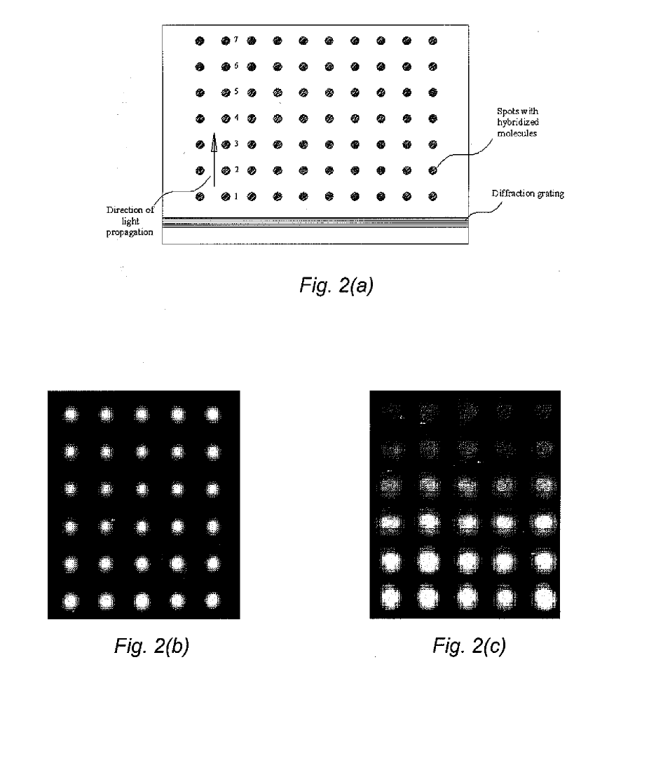

A waveguide can be used to detect specific types of analytes present in a biological sample. Such a waveguide can have one or more spots where analytes of interest can hybridize to a working surface of the waveguide sensor. Referring now to FIG. 2, the top surface (30) of a waveguide (10) is shown with a diffraction grating (18). The top surface (30) includes a plurality of sensing areas or spots (32) arranged in an array. The spots can be arranged in a variety of configurations. For example, the waveguide can have one or more columns of detection sites. The column can include a series of detection sites (e.g., sequential) that would be coincident (or parallel) with the direction of light propagation through the waveguide. The column may have at least one and more often several detection sites. Typically, the detection sites are spaced equidistantly from one another. The detection sites may be spaced at variable positions to each other as well. In another example, the waveguide can have one or more rows of detection sites. The row can include a series of detection sites that would be substantially perpendicular to the direction of light propagation through the waveguide. The row may have at least one and more often several detection sites. Typically, the detection sites are spaced equidistantly from one another. The detection sites also may be spaced at variable positions relative to each other.

Returning to FIG. 2, light of excitation enters into the waveguide (10) and propagates in the direction from the source to spot 1, spot 2, spot 3, etc., consecutively in the same column. The intensity of excitation light at spot 2 can be affected by the interaction between light and any analyte (or dye or other absorbance) at spot 1. Likewise, the intensity of light at spot 3 can be reduced by the absorption of light by any absorbing molecules at spots 1 and 2. Thus, the intensity of light at a given spot can be a function of the concentration of absorbing molecules at all preceding locations.

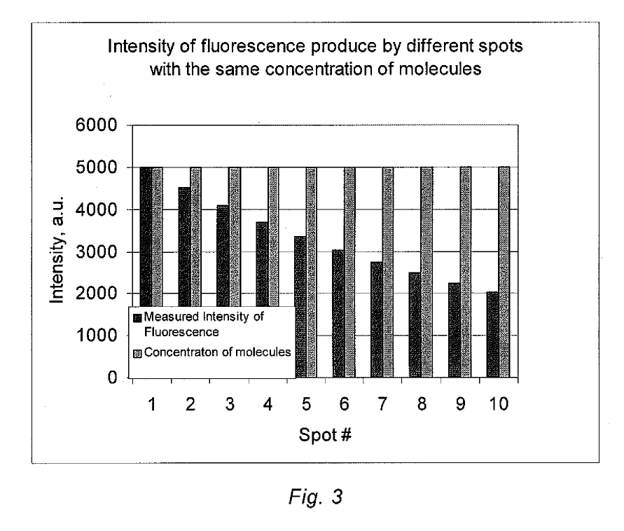

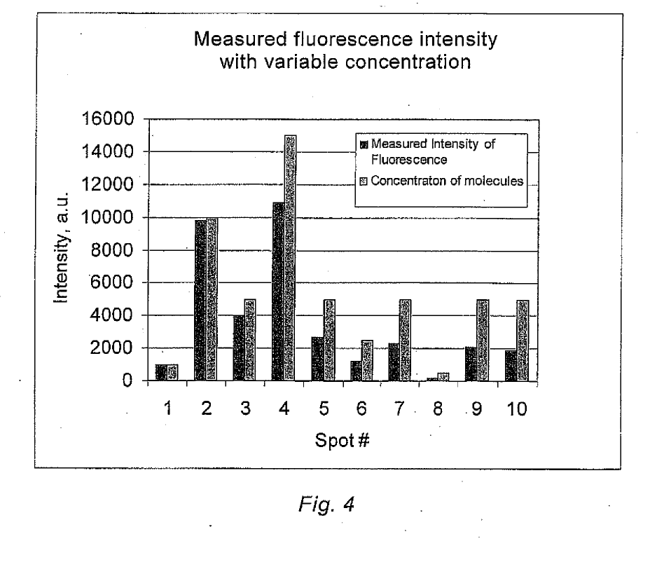

When excitation light propagates through the waveguide film, light intensity decreases due to absorption by the molecules bound at sensing spots (with or without dye), and also due to light absorption and scattering in the waveguide film itself. As a result, the intensity of excitation light at spots 1, 2, 3, etc., (see FIG. 2) located closer to a light source is greater than the intensity of excitation light at spots located further away (spots 7, 6, 5, etc.). The difference in observed fluorescence is depicted in FIGS. 3 and 4. FIG. 3 depicts experimentally observed fluorescence intensity at spots on a waveguide with a relatively low concentration of hybridized molecules. FIG. 4 depicts experimentally observed fluorescence intensity at spots on a waveguide with a relatively high concentration of hybridized molecules showing a continual reduction of light intensity at locations that are farther from a light source. As can be seen from these figures, the decrease in fluorescence may be more pronounced with higher concentrations of hybridized molecules.

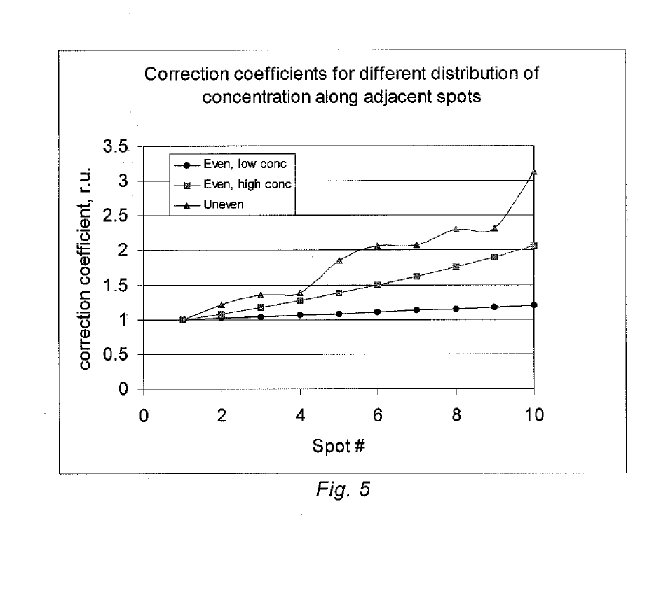

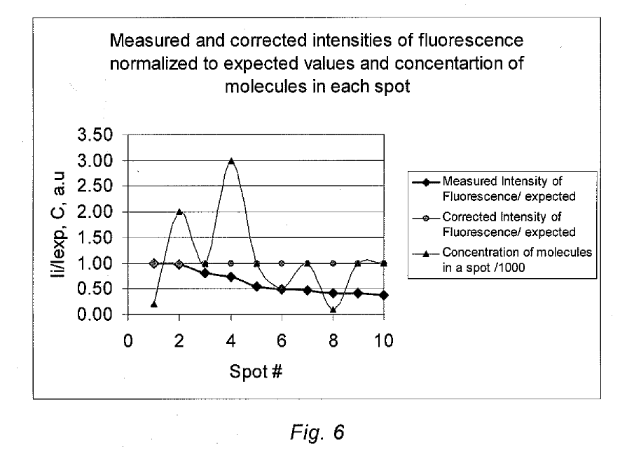

Failure to account for these absorptions (the decrease in excitation light intensity) from one spot to another (i.e., decreases by the analyte) results in a systematic error such that the calculated concentration of analyte at any given spot is underestimated (or undercounted). This error difference may be as high as 50%-100% or even more for highly concentrated molecules at hybridized spots. For example, FIG. 5 illustrates (in a bar graph) fluorescence intensity at waveguide locations spaced sequentially (e.g., linear along a path of transmitted light from a light source). Even though the concentration of analyte remains the same at each of the sensing locations, the fluorescence intensity continually decreases with increasing distance from the light source. When the concentration of molecules is different in each spot (which is often the case) correction of the signal based on an analytical function of distance becomes even more difficult or even impossible as illustrated in FIG. 6. FIG. 6 illustrates (in a bar graph) fluorescence intensity at waveguide locations spaced sequentially (e.g., linearly) from a light source when the concentration of analyte varies from one sensing location to another.

Corrections for Analyte Absorptions

In one aspect, the instant disclosure describes methods for adjusting fluorescence measurements at each spot on a waveguide to account for absorptions at all preceding spots along the direction of propagated light (see FIG. 2). A correction coefficient can be calculated for each spot and measured values of fluorescence can be adjusted using the corresponding correction coefficient. The correction coefficient can be unique for each location. Under some circumstances, the correction coefficient for two sensing locations can be the same. The resulting corrected fluorescence value obtained for any given spot (or capture site) more accurately measures the actual number of molecules hybridized to a waveguide surface at a specific detection site. Thus, the present methods provide an approach for the correction of fluorescent waveguide measurements. The correction can be applied directly to the experimentally obtained fluorescence data without subsequent calibration experiments. Additionally, wavelength-dependent correction factors may be obtained and applied separately or simultaneously. Hence, mechanical alterations to the experimental fluorescence set-up can be obviated.

In another aspect, methods are provided for correction of fluorescence measurements, where fluorescence is directly recalculated without having to perform further calibration experiments.

The intensity of excitation light (Iexₖ) at a spot k is a function of the initial intensity (Iex₀) of excitation in a given direction and the number of absorbing molecules (N) preceding the detection site (or spot). For the first detection site, there are no preceding spots and thus no competing absorptions. Hence, the first spot experiences excitation light intensity that is equal to the intensity of the light source itself represented by the following expression:

Iex₁=Iex₀ (1)

Subsequent spots experience excitation light that is less than the intensity of the light source when preceding spots contain molecules that absorb some quantity of light that will not continue to propagate through the waveguide. The intensity of light reaching a second spot (Iex₂) subsequent to the first spot is a function of the intensity of the light source itself and the intensity of light absorbed at the first spot. This relationship may be expressed as:

Iex₂=I₀·e^{-αN}^{₁} (2)

where I₀ is the intensity of light from the light source, α is the molar absorptivity coefficient for the absorbing species, N₁ is the number (or concentration) of molecules at spot 1.

Similarly, the intensity of light reaching a third spot (Iex₃) is a function of the intensity of the light source itself and the intensity of the light absorbed by the two preceding spots. This relationship may be expressed as:

Iex₃I₀·e^{-αN}^{₁}e^{-αN}^{₂}=I₀·e^{-α(N}^{₁}^{+N}^{₂}⁾ (3)

where N₂ is the concentration of molecules at spot 2. Thus, the corrected intensity of excitation light at any given spot (Iexₖ) is a function of both the initial intensity of the light source and the amount of light absorption at all previous spots i. This general relationship may be expressed by the equation:

$${Iex}_{k} = {f}_{1 k} {Iex}_{0} = {Iex}_{0} \cdot {e}^{- α {\sum }_{i = 1}^{k - 1} {N}_{i}} \qquad ( 4 )$$

where ƒ₁ₖ is the excitation correction factor, α is the absorption coefficient of hybridized molecules at the wavelength of excitation (also called the molar absorptivity of the absorber), k is the spot number of investigation or correction, i is the spot number for one or more spots in the path to spot k, and Nᵢ is the concentration of molecules in a spot. In other words, the intensity of exciting light (Iexₖ) in a waveguide can be calculated as the light source intensity (Iex₀) multiplied by the exponential function of the negative absorbance of all preceding spots. Thus, the empirically derived value of excitation light intensity is multiplied by excitation correction factor ƒ₁ₖ, also expressed according to the equation:

$${f}_{1 k} = {e}^{- α {\sum }_{i = 1}^{k - 1} {N}_{i}} \qquad ( 5 )$$

The absorption coefficient of hybridized molecules at the wavelength of excitation (α) varies with the absorbing material and also with wavelength. The absorption coefficient α can be determined by experiment and expressed as:

$$α = \frac{4 π k}{λ}$$

where k is the extinction coefficient of the material and λ is the wavelength of light.

Corrections for Waveguide Attenuation

In another aspect, the instant disclosure describes methods for adjusting fluorescence measurements at each spot on a waveguide to account for light attenuation (e.g., absorptions or scattering) from the waveguide itself along the path of propagated light. A correction coefficient can be calculated for each coordinate and measured values of fluorescence can be adjusted using the corresponding correction coefficient. The correction coefficient may, therefore, account for absorption and light scattering in the waveguide film itself. Such losses occur along the propagation of light between sensing locations by light absorption in the waveguide film. The resulting corrected fluorescence value obtained for any given spot coordinate more accurately measures the actual number of molecules hybridized to a waveguide surface at that coordinate. Thus, the present methods provide an approach for the correction of fluorescent waveguide measurements. The correction can be applied directly to the experimentally obtained fluorescence data without subsequent calibration experiments.

Corrected intensity of excitation light (Iexₖ) may be expressed by the equation:

Iexₖ=ƒ₂ₖIex₀=Iexe^{-ξ(x}^{ₖ}^{-x}^{₀}⁾ (6)

where ƒ₂ₖ is the excitation correction factor, ξ is the coefficient of linear attenuation of the waveguide material at the wavelength of the excitation light (often expressed in units of cm⁻¹), xₖ is the coordinate of the k-th spot, x₀ is the coordinate of the origin (or diffraction grating). Thus, the intensity of excitation light is multiplied by an excitation correction factor expressed by the following equation:

ƒ₂ₖ=e^{-ξ(x}^{ₖ}^{-x}^{₀}⁾ (7)

Corrections for Analyte and Waveguide Attenuation

In still another aspect, more than one correction factor can be applied simultaneously to account for linear attenuation in the waveguide material and by analyte or other molecular absorptions according to the following equation:

$${Iex}_{k} = {Iex}_{0} \cdot {f}_{3 k} = {Iex}_{0} \cdot {e}^{- ξ ( {x}_{k} - {x}_{0} )} \cdot {e}^{- α {\sum }_{i = 1}^{k - 1} {N}_{i}} \qquad ( 8 )$$

where ƒ₃ₖ is expressed by the equation:

$${f}_{3 k} = {e}^{- ξ ( {x}_{k} - {x}_{0} )} \cdot {e}^{- α {\sum }_{i = 1}^{k - 1} {N}_{i}} \qquad ( 9 )$$

In this equation, the variables have the same meaning defined previously. As seen in from these equations, the corrected intensity of excitation light is multiplied by two correction factors ƒ₁ₖ and ƒ₂ₖ, expressed as:

$$\begin{matrix}{e}^{- ξ ( {x}_{k} - {x}_{0} )} \\ and & ( 10 ) \\ {e}^{- α {\sum }_{i = 1}^{k - 1} {N}_{i}} \\ respectively , & ( 11 )\end{matrix}$$

accounting for absorptions in the waveguide film and absorptions at previous spots.

Corrections for Light Collection Efficiency

In yet another aspect, the light collection efficiency of the assay system (γₖ) affects the intensity of fluorescence. The corrected intensity of detected fluorescence (I_{Fk}) from each spot number (k), can also be expressed as follows:

$${I}_{Fk} = {Iex}_{k} \cdot {γ}_{k} \cdot {N}_{k} = {γ}_{k} \cdot {N}_{k} \cdot {Iex}_{0} \cdot {e}^{- α {\sum }_{i = 1}^{k - 1} {N}_{i}} \qquad ( 12 )$$

or alternatively expressed by the equation:

I_{Fk}=Iex₀19 ƒ₁ₖ·γₖ·Nₖ (13)

where α is the absorption coefficient of hybridized analyte at an excitation wavelength, k is the spot number, i is the spot number for one or more spots in the path to spot k, Nᵢ is the analyte concentration at a spot preceding spot k, Nₖ is the analyte concentration at spot k, γₖ is the collection coefficient of fluorescent light at a spot k, Iexₖ is the initial light intensity, ƒ₁ₖ has the meaning defined above, and I_{Fk} is the corrected intensity of detected fluorescence.

The value of γₖ (collection efficiency) can be constant or can have a functional dependence upon the coordinate of the location of a spot, such as when a vignette effect is present. γₖ can be calculated based on the focal distance of the objective lens used for light collection, numerical aperture of this lens and magnification of the optical system. The collection coefficient can be different for different spots if the optical system is not properly designed. Typically collection efficiency is lower at the periphery of the field of view of the optical system. The distribution of γₖ across the waveguide can also be measured experimentally. γₖ can determined by exposing a waveguide or chip to a standard light source with measurements of light at any given spot on the waveguide.

Measured fluorescence intensity may be normalized for the concentration of hybridized analyte and light collection efficiency. Such normalization can provide a baseline value of 1 if the signal intensity is correctly measured.

In another embodiment, the corrected intensity of detected fluorescence (I_{Fk}) from each spot number (k), can be expressed as follows:

I_{Fk}=Iexₖ·Nₖ·γₖ=Nₖ·γₖ·Iex₀·e^{-ξ(x}^{ₖ}^{-x}^{₀}⁾ (14)

or alternatively expressed by the equation:

I_{Fk}=Iex₀·ƒ₂ₖ·γₖ·Nₖ (15)

where α is the absorption coefficient of hybridized analyte at an excitation wavelength, k is the spot number, i is the spot number for one or more spots in the path to spot k, Nᵢ is the analyte concentration at a spot, γₖ is the collection coefficient of fluorescent light at a spot k, Iexₖ is the initial light intensity, ƒ₂ₖ has the meaning defined above, and I_{Fk} is the corrected intensity of detected fluorescence.

In yet another embodiment, the corrected intensity of detected fluorescence (I_{Fk}) from each spot number (k), can be expressed as follows:

$${I}_{Fk} = {Iex}_{k} \cdot {γ}_{k} \cdot {N}_{k} = {γ}_{k} \cdot {N}_{k} \cdot {Iex}_{0} \cdot {e}^{- α {\sum }_{i = 1}^{k - 1} {N}_{i}} \cdot {e}^{- ξ ( {x}_{k} - {x}_{0} )} \qquad ( 16 )$$

or alternatively expressed by the equation:

I_{Fk}=Iex₀·ƒ₃ₖ·γₖ·Nₖ (17)

where α is the absorption coefficient of hybridized analyte at an excitation wavelength, k is the spot number, i is the spot number for one or more spots in the path to spot k, Nᵢ is the analyte concentration at a spot, γₖ is the collection coefficient of fluorescent light at a spot k, Iexₖ is the initial light intensity, ƒ₃ₖ has the meaning defined above, and I_{Fk} is the corrected intensity of detected fluorescence.

The equations and correction coefficients described above may be applied in a variety of contexts such as low, high, or variable concentrations of analyte. Referring to FIG. 7, the graph illustrates values of correction coefficients applying to (1) low concentration of analyte, (2) high concentration of analyte, and (3) variable concentration of analyte. When experimental conditions involve low concentrations of analyte, then the correction factors can be very close to the value of 1. When experimental conditions involve high concentrations of analyte, the correction coefficients for sensing locations farther from a light source are greater than correction coefficients for sensing locations closer to a light source. When the concentration of molecules is different in each spot (which is often the case) correction coefficients may or may not be greater (and may be the same) for sensing locations farther from a light source than correction coefficients for sensing locations closer to a light source.

Referring to FIG. 8, the graph illustrates values of fluorescence intensity when the concentration of an analyte varies from one sensing location to another. After applying correction factors to account for analyte absorptions, the fluorescence intensity is normalized to a value of 1.

In general, correction coefficients may be close to 1 for low concentrations of hybridized molecules and as high as 2 or greater for higher concentrations. In addition, correction coefficients at each spot may vary if the concentration of hybridized molecules varies from spot to spot (see Example 3, FIG. 7).

Multicolor or Spectrally Distinct Label Corrections

In yet another aspect, the instant disclosure describes methods for adjusting, i.e., correcting, fluorescence measurements in multicolor experiments (experiments involving spectrally distinct labels). A correction coefficient can be calculated for each coordinate, at each spot, associated with a desired number of wavelengths (or frequencies). The measured values of fluorescence can be adjusted using the corresponding correction coefficient(s). The correction coefficient may, therefore, account for absorptions such as analyte absorptions in previous spots, in the waveguide film itself, or a combination of these absorptions for each wavelength of interest. The resulting corrected fluorescence value obtained for any given spot or coordinate at each wavelength more accurately measures the actual number of molecules hybridized to a waveguide surface at that coordinate. Thus, the present methods provide another approach for the correction of fluorescent waveguide measurements. The correction can be applied directly to the experimentally obtained fluorescence data without subsequent calibration experiments.

In multicolor experiments or spectrally distinct label experiments, corrected intensity of excitation light (Iexₖ) may be calculated based on the fluorescence intensities of all spectrally distinct labels (different dyes, for example) used for labeling. Corrected intensity of excitation light (Iexₖ) in a multicolor experiment may be expressed by the equation:

$${Iex}_{k} = {Iex}_{0} \cdot {f}_{4 k} = {Iex}_{0 \cdot } {e}^{- {\sum }_{m = 1}^{p} {α}_{m} \cdot {\sum }_{i = 1}^{k} {N}_{i}} \qquad ( 18 )$$

where αₘ is the absorption coefficient for a particular color (wavelength), p is the number of colors used for labeling. In this case, α is a function of λₘ, the wavelength of a particular color used for labeling, since absorption is wavelength dependent. Thus, the intensity of excitation light is multiplied by an excitation correction factor expressed by the following equation:

$${f}_{4 k} = {e}^{- {\sum }_{m = 1}^{p} {α}_{m} \cdot {\sum }_{i = 1}^{k} {N}_{i}} \qquad ( 19 )$$

In another embodiment, the fluorescence correction coefficient comprises more than one multicolor correction factor. For example, the corrected intensity of excitation light Iexₖ can be calculated according to the equation:

$${Iex}_{k} = {Iex}_{0} \cdot {f}_{5 k} = {Iex}_{0} \cdot {e}^{- {\sum }_{m = 1}^{p} {α}_{m} {\sum }_{i = 1}^{k} {N}_{i}} \cdot {e}^{- ξ ( {x}_{k} - {x}_{0} )} \qquad ( 20 )$$

where αₘ is the absorption coefficient of hybridized analyte at an excitation wavelength λₘ, k is the spot number, i is the spot number for one or more spots in the path to spot k, Nᵢ is the analyte concentration at a spot k, p is the number of colors used for labeling, Iexₖ is the corrected intensity of excitation light at a given position, i is the spot number for one or more spots in a path to spot k, ξ is the linear attenuation coefficient of the waveguide material at an excitation wavelength λₘ, xₖ is the k-th spot coordinate, x₀ is the origin coordinate, and Iex₀ is the initial light intensity. Thus, the intensity of excitation light is multiplied by an excitation correction factor expressed by the following equation:

$${f}_{5 k} = {e}^{- {\sum }_{m = 1}^{p} {α}_{m} {\sum }_{i = 1}^{k} {N}_{i}} \cdot {e}^{- ξ ( {x}_{k} - {x}_{0} )} \qquad ( 21 )$$

Waveguide Detection Sites

The methods for correcting waveguide measurements described above are applicable for a variety of waveguides. For example, they may be used in waveguides with a plurality of detection sites that are aligned in at least one sequential column (e.g., linear along a path of transmitted light) from a light source. They may also be used in waveguides with a plurality of detection sites that includes two or more linear columns. They may also be used in waveguides with a plurality of detection sites that include a linear column of two or more detection sites. They may also be used in waveguides with a plurality of detection sites that include a linear column of at least three detection sites. They may also be used in waveguides with a plurality of detection sites that includes a row of detection sites not in linear order along the direction of propagated light.

The methods for correcting waveguide measurements described above may be used with samples containing one target analyte. They may also be used with samples containing a plurality of target analytes, e.g., 2, 3, 4, 5, 6, 7, 8, 9, 10.

The methods for correcting waveguide measurements described above may be used to more accurately quantify the amount of target analyte present at a detection site (i.e., the amount of a target analyte in a sample).

### EXAMPLE

### Example 1

A waveguide chip (substrate with waveguide film deposited on its surface) can be obtained form Oerlikon, Chuerstrasse, Switzerland. The waveguide can be prepared by etching of a diffractive grating on the surface of the glass followed by vacuum deposition of a high refractive index material such as Ta₂O₅, TiO₂ or other similar materials. The surface of the waveguide film can be covered by a polymer such as KBD, Lupanine, or similar polymer. Capture probes can be spotted on the polymer surface. Optionally, a labeling dye such as AlexaFluor® 647 may be included. The amount of labeled molecules in the analyte solution may vary from 10⁻¹²-10⁻¹⁵ M. The solution can be brought into contact with the waveguide and allowed to hybridize for 2-24 hours. The waveguide can be irradiated with a light source such as a semiconductor laser with the wavelength of 635 nm, for example, from Lasiris Montreal, Quebec, Canada (Part number LAS635S10).

1. A method of detecting a target analyte, comprising:
providing a waveguide comprising a plurality of detection sites;
contacting the waveguide with a test sample suspected of containing an unknown concentration of the target analyte;
irradiating the waveguide;
measuring fluorescence intensity values at the plurality of detection sites; and
multiplying the fluorescence intensity value specific to each detection site by a fluorescence correction coefficient, resulting in a corrected intensity of excitation light.

2. A method of calculating a correction coefficient for use in a waveguide fluorescence measurement, comprising:
providing a waveguide comprising a plurality of detection sites;
contacting the waveguide with a control sample comprising a known concentration of a target analyte;
irradiating the waveguide;
measuring fluorescence intensity values at the plurality of detection sites; and
calculating a fluorescence correction coefficient specific to each detection site, whereby multiplying the fluorescence correction coefficient with a non-control sample measurement results in a corrected intensity of excitation light.

3. The method of claim 1, wherein,
the waveguide includes a substrate and a waveguide film,
each of the plurality of detection sites is capable of specifically binding a target analyte, and
fluorescence is indicative of the presence of the target analyte.

4. The method according to claim 1, wherein the fluorescence correction coefficient includes an excitation correction factor.

5. The method according to claim 4, wherein the excitation correction factor ƒ₁ₖ is calculated according to the equation:
$${f}_{1 k} = {e}^{- α {\sum }_{i = 1}^{k - 1} {N}_{i}}$$
wherein α is the absorption coefficient of hybridized analyte at an excitation wavelength, k is the spot number, i is the spot number for one or more spots in a path to spot k, and Nᵢ is the analyte concentration at a spot.

6. The method according to claim 5, wherein the corrected intensity of excitation light Iexₖ is calculated according to the equation:
Iexₖ=ƒ₁ₖ·Iex₀
where Iex₀ is the initial light intensity.

7. The method according to claim 4, wherein the excitation correction factor accounts for analyte absorption at all detection sites preceding a specific detection site.

8. The method according to claim 4, wherein the excitation correction factor ƒ₂ₖ is calculated according to the equation:
ƒ₂ₖ=e^{-ξ(x}^{ₖ}^{-x}^{₀}⁾
wherein ξ is the coefficient of linear attenuation of the waveguide material at an excitation wavelength, xₖ is the k-th spot coordinate, and x₀ is the origin coordinate.

9. The method according to claim 8, wherein the corrected intensity of excitation light Iexₖ is calculated according to the equation:
Iexₖ=ƒ₂ₖ·Iex₀
where Iex₀ is the initial light intensity.

10. The method according to claim 4, wherein the excitation correction factor accounts for waveguide-material absorption along the waveguide between a light source and a specific detection site.

11. The method according to claim 1, wherein the fluorescence correction coefficient comprises more than one correction factor.

12. The method according to claim 11, wherein the more than one correction factor includes an excitation correction factor ƒ₃ₖ that is calculated according to the equation:
$${f}_{3 k} = {e}^{- ξ ( {x}_{k} - {x}_{0} )} \cdot {e}^{- α {\sum }_{i = 1}^{k - 1} {N}_{i}}$$
wherein ξ is the linear attenuation coefficient of the waveguide material at an excitation wavelength, xₖ is the k-th spot coordinate, x₀ is the origin coordinate, α is the absorption coefficient of hybridized analyte at the excitation wavelength, k is the spot number, i is the spot number for one or more spots in a path to spot k, and Nᵢ is the analyte concentration at a spot.

13. The method according to claim 12, wherein the corrected intensity of excitation light Iexₖ is calculated according to the equation:
Iexₖ=ƒ₃ₖ·Iex₀
where Iex₀ is the initial light intensity.

14. The method according to claim 11, wherein the more than one correction facor include an excitation correction factor that accounts for analyte absorption at all detection sites preceding a specific detection site and waveguide-material absorption along the waveguide between a light source and the specific detection site.

15. (canceled)

16. (canceled)

17. The method according to claim 5, wherein the corrected intensity of detected fluorescence I_{Fk} is calculated according to the equation:
I_{Fk}=Iex₀·ƒ₁ₖ·γₖ·Nₖ
where γₖ is the collection coefficient of fluorescent light at a spot k, Iex₀ is the initial light intensity, and Nₖ is the analyte concentration at spot k.

18. The method according to claim 17, wherein the excitation correction factor accounts for analyte absorption at all detection sites preceding a specific detection site.

19. (canceled)

20. The method according to claim 8, wherein the corrected intensity of detected fluorescence I_{Fk} is calculated according to the equation:
I_{Fk}=Iex₀·ƒ₂ₖ·γₖ·Nₖ
where γₖ is the collection coefficient of fluorescent light at a spot k, Iex₀ is the initial light intensity, and Nₖ is the analyte concentration at spot k.

21. The method according to claim 20, wherein the excitation correction factor accounts for waveguide-material absorption along the waveguide between a light source and a specific detection site.

22. The method according to claim 17, wherein the fluorescence correction coefficient comprises more than one correction factor.

23. (canceled)

24. The method according to claim 12, wherein the corrected intensity of detected fluorescence I_{Fk} is calculated according to the equation:
I_{Fk}=Iex₀·ƒ₃ₖ·γₖ·Nₖ
where γₖ is the collection coefficient of fluorescent light at a spot k, Iex₀ is the initial light intensity, and Nₖ is the analyte concentration at spot k.

25. The method according to claim 24, wherein the emission correction factor accounts for analyte absorption at all detection sites preceding a specific detection site and waveguide-material absorption along the waveguide between a light source and the specific detection site.

26. The method according to claim 1, wherein the one or more fluorescence correction coefficients include a multicolor excitation correction factor.

27. The method according to claim 26, wherein the multicolor excitation correction factor ƒ₄ₖ is calculated according to the equation:
$${f}_{4 k} = {e}^{- {\sum }_{m = 1}^{p} {α}_{m} \cdot {\sum }_{i = 1}^{k} {N}_{i}}$$
wherein αₘ is the absorption coefficient of hybridized analyte at an excitation wavelength λₘ, k is the spot number, i is the spot number for one or more spots in the path to spot k, Nᵢ is the analyte concentration at a spot, and p is the number of colors used for labeling.

28. The method according to claim 27, wherein the corrected intensity of excitation light Iexₖ is calculated according to the equation:
Iexₖ=Iex₀·ƒ₄ₖ
where Iex₀ is the initial light intensity.

29. The method according to claim 27, wherein the multicolor excitation correction factor accounts for analyte absorption at all detection sites preceding a specific detection site at more than one wavelength of light.

30. The method according to claim 26, wherein the multicolor excitation correction factor is calculated according to the equation:
ƒ₂ₖ=e^{-ξ(x}^{ᵢ}^{-x}^{₀}⁾
wherein ξ is the linear attenuation coefficient of the waveguide material at an excitation wavelength, xᵢ is the i-th spot coordinate, and x₀ is the origin coordinate.

31. The method according to claim 30, wherein the corrected intensity of excitation light Iexₖ is calculated according to the equation:
Iexₖ=ƒ₂ₖ·Iex₀
where Iex₀ is the initial light intensity.

32. The method according to claim 30, wherein the multicolor excitation correction factor accounts for waveguide-material absorption along the waveguide between a light source and a specific detection site.

33. The method according to claim 26, wherein the fluorescence correction coefficient comprises more than one multicolor correction factor.

34. The method according to claim 33, wherein the multicolor excitation correction factor ƒ₅ₖ is calculated according to the equation:
$${f}_{5 k} = {e}^{- {\sum }_{m = 1}^{p} {α}_{m} {\sum }_{i = 1}^{k} {N}_{i}} \cdot {e}^{- ξ ( {x}_{k} - {x}_{0} )}$$
wherein αₘ is the absorption coefficient of hybridized analyte at an excitation wavelength λₘ, k is the spot number, i is the spot number for one or more spots in the path to spot k, Nᵢ is the analyte concentration at a spot k, p is the number of colors used for labeling, Iexₖ is the corrected intensity of excitation light at a given position, i is the spot number for one or more spots in a path to spot k, ξ is the linear attenuation coefficient of the waveguide material at an excitation wavelength λₘ, xₖ is the k-th spot coordinate, and x₀ is the origin coordinate.

35. The method according to claim 34, wherein the corrected intensity of excitation light Iexₖ is calculated according to the equation:
Iexₖ=ƒ₅ₖ·Iex₀
where Iex₀ is the initial light intensity.

36. The method according to claim 33, wherein the multicolor excitation correction factor accounts for analyte absorption at all detection sites preceding a specific detection site and waveguide-material absorption along the waveguide between a light source and the specific detection site at more than one wavelength of light.

37. The method according to claim 1, wherein the plurality of detection sites is aligned in at least one linear column from a light source.

38. The method according to claim 1, wherein the plurality of detection sites includes two or more linear columns.

39. The method according to claim 1, wherein the plurality of detection sites includes a linear column of two or more detection sites.

40. The method according to claim 1, wherein the plurality of detection sites includes a linear column of at least three detection sites.

41. The method according to claim 1, wherein the plurality of detection sites includes a row of detection sites not in linear order along the direction of propagated light.

42. The method according to claim 1, wherein the target analyte comprises one or more target analytes.
